(19) United States
(12) Patent Application Publication
(10) Pub. No.: US 2026/0129675 A1
(43) Pub. Date: May 7, 2026

(54) METHOD AND APPARATUS FOR WIRELESS COMMUNICATION

(71) Applicant: NOKIA TECHNOLOGIES OY, Espoo (FI)

(72) Inventors: Behnam DEZFOULI, San Jose, CA (US); Klaus Franz DOPPLER, Albany, CA (US); Anna LE, San Jose, CA (US); Claude ROBERTSON, New York, NY (US)

(21) Appl. No.: 18/939,421

(22) Filed: Nov. 6, 2024

(51) Int. Cl. H04W 74/0808

(52) U.S. Cl. CPC H04W 74/0808

(57) ABSTRACT

An apparatus, method, and computer program product are provided for generating a frame associated with a shared transmission opportunity (TXOP). The frame indicates at least one of (i) whether a station (STA) can communicate during the shared TXOP with (a) the apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP. The apparatus, method, and computer program product further provide for transmitting the frame to the STA.

### TECHNOLOGICAL FIELD

An apparatus, method and computer program product are provided for wireless communication in which communicating according to an enhanced reverse direction (RD) sharing protocol to support transmission opportunity (TXOP) sharing may be employed.

### BACKGROUND

Some applications of wireless technologies rely on low latency data exchange. For example, stations (STAs) such as Wi-Fi STAs, may need to support applications relying on low latency data exchange, for example, virtual reality, mixed reality, and augmented reality applications.

### BRIEF SUMMARY

An apparatus, method and computer program product are provided for communicating according to an improved reverse direction (RD) sharing protocol.

According to an aspect of the present disclosure, there is provided an apparatus including at least one processor; and at least one memory storing instructions that, when executed by the at least one processor, cause the apparatus to perform at least: generating a frame associated with a shared transmission opportunity (TXOP). The frame indicates at least one of (i) whether a station (STA) can communicate during the shared TXOP with (a) the apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP. The apparatus is also caused to perform at least transmitting the frame to the STA.

According to some embodiments, the frame includes at least two subfields encoded to indicate whether the STA can communicate during the shared TXOP with (a) the apparatus or (b) the apparatus and the one or more other STAs. The at least two subfields of some embodiments include at least one of extended encodings of a reverse direction grant (RDG) subfield or extended encodings of an access category (AC) constraint subfield. The frame of certain embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of certain embodiments indicates the maximum duration of the shared TXOP during which the STA can communicate.

According to some embodiments, the frame indicates, via the RDG subfield and the AC constraint subfield, that the STA can communicate during the shared TXOP with only the apparatus. According to other embodiments, the frame indicates, via the RDG subfield and the AC constraint subfield, that the STA can communicate during the shared TXOP with the apparatus and one or more other STAs. The apparatus of some embodiments is also caused to at least perform receiving a response frame from the STA. In this embodiment, the response frame from the STA indicates at least one of the following: that the STA accepts the shared TXOP, that the STA does not accept the shared TXOP, or that the STA has provided a counteroffer. The counteroffer from the STA of some embodiments indicates at least one of a request to communicate with the apparatus, or a request to communicate with the apparatus and one or more other STAs, or one or more permissible traffic types to be communicated, or one or more permissible streams to be communicated, or a minimum duration of the shared TXOP during which the STA can communicate. The apparatus of some embodiments is also caused to at least perform receiving a response frame from the STA indicating the counteroffer from the STA; generating a second frame based at least in part on the counteroffer from the STA; and transmitting the second frame to the STA. As used herein, a frame is designated as second only to distinguish the frame from other frames and there is no implication of any positional or temporal order for the frame relative to other frames.

The apparatus of some embodiments is also caused to at least perform generating a second frame during the shared TXOP; and transmitting the second frame to the STA during the shared TXOP. In this embodiment, the second frame indicates an update to at least one of whether the STA can communicate during the shared TXOP with (a) the apparatus or (b) the apparatus and one or more other STAs, or the maximum duration of the shared TXOP during which the STA can communicate, or one or more permissible traffic types that can be communicated during the shared TXOP, or one or more permissible streams that can be communicated during the shared TXOP, or the second frame indicates a termination of the shared TXOP. The frame of some embodiments indicates a minimum duration or an exact duration until a next shared TXOP instance without providing a TXOP offer. The apparatus of some embodiments is also caused to at least perform receiving a frame from the STA; generating a second frame based at least in part on the request for a shared TXOP; and transmitting the second frame to the STA. In this embodiment, the frame is a request for a shared TXOP. The apparatus of some embodiments is also caused to at least perform receiving a frame from the STA. In this embodiment, the frame is a request received during the shared TXOP, the request indicates a termination of the TXOP, and the request indicates a request for a new shared TXOP. According to some embodiments, the apparatus includes an access point (AP) STA or a non-AP STA.

According to another aspect of the present disclosure, there is provided a method including generating a frame associated with a shared transmission opportunity (TXOP). The frame indicates at least one of (i) whether a station (STA) can communicate during the shared TXOP with (a) an apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP. The method also includes transmitting the frame to the STA.

According to some embodiments, the frame includes at least two subfields encoded to indicate whether the STA can communicate during the shared TXOP with (a) the apparatus or (b) the apparatus and the one or more other STAs. The at least two subfields of some embodiments include at least one of extended encodings of a reverse direction grant (RDG) subfield or extended encodings of an access category (AC) constraint subfield. The frame of certain embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of certain embodiments indicates the maximum duration of the shared TXOP during which the STA can communicate.

According to some embodiments, the frame indicates, via the RDG subfield and the AC constraint subfield, that the STA can communicate during the shared TXOP with only the apparatus. According to other embodiments, the frame indicates, via the RDG subfield and the AC constraint subfield, that the STA can communicate during the shared TXOP with the apparatus and one or more other STAs. The method of some embodiments further includes receiving a response frame from the STA. In this embodiment, the response frame from the STA indicates at least one of the following: that the STA accepts the shared TXOP, that the STA does not accept the shared TXOP, or that the STA has provided a counteroffer. The counteroffer from the STA of some embodiments indicates at least one of a request to communicate with the apparatus, or a request to communicate with the apparatus and one or more other STAs, or one or more permissible traffic types to be communicated, or one or more permissible streams to be communicated, or a minimum duration of the shared TXOP during which the STA can communicate. The method of some embodiments further includes receiving a response frame from the STA indicating the counteroffer from the STA; generating a second frame based at least in part on the counteroffer from the STA; and transmitting the second frame to the STA.

The method of some embodiments further includes generating a second frame during the shared TXOP; and transmitting the second frame to the STA during the shared TXOP. In this embodiment, the second frame indicates an update to at least one of whether the STA can communicate during the shared TXOP with (a) the apparatus or (b) the apparatus and one or more other STAs, or the maximum duration of the shared TXOP during which the STA can communicate, or one or more permissible traffic types that can be communicated during the shared TXOP, or one or more permissible streams that can be communicated during the shared TXOP, or the second frame indicates a termination of the shared TXOP. The frame of some embodiments indicates a minimum duration or an exact duration until a next shared TXOP instance without providing a TXOP offer. The method of some embodiments further includes receiving a frame from the STA; generating a second frame based at least in part on the request for a shared TXOP; and transmitting the second frame to the STA. In this embodiment, the frame is a request for a shared TXOP. The method of some embodiments further includes receiving a frame from the STA. In this embodiment, the frame is a request received during the shared TXOP, the request indicates a termination of the TXOP, and the request indicates a request for a new shared TXOP. According to some embodiments, the apparatus includes an access point (AP) STA or a non-AP STA.

According to an aspect of the present disclosure, there is provided a computer program product, including at least one non-transitory computer-readable storage medium having computer-executable program code portions stored therein with the computer-executable program code portions comprising program code instructions configured to generate a frame associated with a shared transmission opportunity (TXOP). The frame indicates at least one of (i) whether a station (STA) can communicate during the shared TXOP with (a) an apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP. The computer-executable program code portions include program code instructions configured to transmit the frame to the STA.

According to some embodiments, the frame includes at least two subfields encoded to indicate whether the STA can communicate during the shared TXOP with (a) the apparatus or (b) the apparatus and the one or more other STAs. The at least two subfields of some embodiments include at least one of extended encodings of a reverse direction grant (RDG) subfield or extended encodings of an access category (AC) constraint subfield. The frame of certain embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of certain embodiments indicates the maximum duration of the shared TXOP during which the STA can communicate.

According to some embodiments, the frame indicates, via the RDG subfield and the AC constraint subfield, that the STA can communicate during the shared TXOP with only the apparatus. According to other embodiments, the frame indicates, via the RDG subfield and the AC constraint subfield, that the STA can communicate during the shared TXOP with the apparatus and one or more other STAs. According to some embodiments, the computer-executable program code portions include program code instructions configured to receive a response frame from the STA. In this embodiment, the response frame from the STA indicates at least one of the following: that the STA accepts the shared TXOP, that the STA does not accept the shared TXOP, or that the STA has provided a counteroffer. The counteroffer from the STA of some embodiments indicates at least one of a request to communicate with the apparatus, or a request to communicate with the apparatus and one or more other STAs, or one or more permissible traffic types to be communicated, or one or more permissible streams to be communicated, or a minimum duration of the shared TXOP during which the STA can communicate. According to some embodiments, the computer-executable program code portions include program code instructions configured to receive a response frame from the STA indicating the counteroffer from the STA; generate a second frame based at least in part on the counteroffer from the STA; and transmit the second frame to the STA.

According to some embodiments, the computer-executable program code portions include program code instructions configured to generate a second frame during the shared TXOP; and transmit the second frame to the STA during the shared TXOP. In this embodiment, the second frame indicates an update to at least one of whether the STA can communicate during the shared TXOP with (a) the apparatus or (b) the apparatus and one or more other STAs, or the maximum duration of the shared TXOP during which the STA can communicate, or one or more permissible traffic types that can be communicated during the shared TXOP, or one or more permissible streams that can be communicated during the shared TXOP, or the second frame indicates a termination of the shared TXOP. The frame of some embodiments indicates a minimum duration or an exact duration until a next shared TXOP instance without providing a TXOP offer. According to some embodiments, the computer-executable program code portions include program code instructions configured to receive a frame from the STA; generate a second frame based at least in part on the request for a shared TXOP; and transmit the second frame to the STA. In this embodiment, the frame is a request for a shared TXOP. According to some embodiments, the computer-executable program code portions include program code instructions configured to receive a frame from the STA. In this embodiment, the frame is a request received during the shared TXOP, the request indicates a termination of the TXOP, and the request indicates a request for a new shared TXOP. According to some embodiments, the apparatus includes an access point (AP) STA or a non-AP STA.

According to an aspect of the present disclosure, there is provided an apparatus, including means for generating a frame associated with a shared transmission opportunity (TXOP). The frame indicates at least one of (i) whether a station (STA) can communicate during the shared TXOP with (a) the apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP. The apparatus also includes means for transmitting the frame to the STA.

According to some embodiments, the frame includes at least two subfields encoded to indicate whether the STA can communicate during the shared TXOP with (a) the apparatus or (b) the apparatus and the one or more other STAs. The at least two subfields of some embodiments include at least one of extended encodings of a reverse direction grant (RDG) subfield or extended encodings of an access category (AC) constraint subfield. The frame of certain embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of certain embodiments indicates the maximum duration of the shared TXOP during which the STA can communicate.

According to some embodiments, the frame indicates, via the RDG subfield and the AC constraint subfield, that the STA can communicate during the shared TXOP with only the apparatus. According to other embodiments, the frame indicates, via the RDG subfield and the AC constraint subfield, that the STA can communicate during the shared TXOP with the apparatus and one or more other STAs. The apparatus of some embodiments also includes means for receiving a response frame from the STA. In this embodiment, the response frame from the STA indicates at least one of the following: that the STA accepts the shared TXOP, that the STA does not accept the shared TXOP, or that the STA has provided a counteroffer. The counteroffer from the STA of some embodiments indicates at least one of a request to communicate with the apparatus, or a request to communicate with the apparatus and one or more other STAs, or one or more permissible traffic types to be communicated, or one or more permissible streams to be communicated, or a minimum duration of the shared TXOP during which the STA can communicate. The apparatus of some embodiments also includes means for receiving a response frame from the STA indicating the counteroffer from the STA; generating a second frame based at least in part on the counteroffer from the STA; and transmitting the second frame to the STA.

The apparatus of some embodiments also includes means for generating a second frame during the shared TXOP; and means for transmitting the second frame to the STA during the shared TXOP. In this embodiment, the second frame indicates an update to at least one of whether the STA can communicate during the shared TXOP with (a) the apparatus or (b) the apparatus and one or more other STAs, or the maximum duration of the shared TXOP during which the STA can communicate, or one or more permissible traffic types that can be communicated during the shared TXOP, or one or more permissible streams that can be communicated during the shared TXOP, or the second frame indicates a termination of the shared TXOP. The frame of some embodiments indicates a minimum duration or an exact duration until a next shared TXOP instance without providing a TXOP offer. The apparatus of some embodiments also includes means for receiving a frame from the STA; generating a second frame based at least in part on the request for a shared TXOP; and transmitting the second frame to the STA. In this embodiment, the frame is a request for a shared TXOP. The apparatus of some embodiments also includes means for receiving a frame from the STA. In this embodiment, the frame is a request received during the shared TXOP, the request indicates a termination of the TXOP, and the request indicates a request for a new shared TXOP. According to some embodiments, the apparatus includes an access point (AP) STA or a non-AP STA.

According to an aspect of the present disclosure, there is provided an apparatus including at least one processor; and at least one memory storing instructions that, when executed by the at least one processor, cause the apparatus to perform at least: receiving, from a station (STA), a frame associated with a shared transmission opportunity (TXOP). The frame indicates at least one of (i) whether the apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

According to some embodiments, the frame includes at least two subfields encoded to indicate whether the apparatus can communicate during the shared TXOP with (a) the STA or (b) the STA and one or more other STAs. The at least two subfields of some embodiments include at least one of extended encodings of a reverse direction grant (RDG) subfield or extended encodings of an access category (AC) constraint subfield. The frame of some embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of some embodiments indicates the maximum duration of the shared TXOP during which the apparatus can communicate.

According to some embodiments, the frame indicates, via the RDG subfield and the AC constraint subfield, that the apparatus can communicate during the shared TXOP with only the STA. According to other embodiments, the frame indicates, via the RDG subfield and the AC constraint subfield, that the apparatus can communicate during the shared TXOP with the STA and one or more other STAs. The apparatus of some embodiments is also caused to at least perform determining to not respond to the frame received from the STA. The apparatus of some embodiments is also caused to at least perform generating, based at least in part on the frame received from the STA, a response frame; and transmitting the response frame to the STA. In this embodiment, the response frame indicates at least one of the following: that the shared TXOP is accepted, that the shared TXOP is not accepted, or a counteroffer. The counteroffer of some embodiments indicates at least one of a request to communicate with the STA, or a request to communicate with the STA and one or more other STAs, or one or more permissible traffic types to be communicated, or one or more permissible streams to be communicated, or a minimum duration of the shared TXOP during which the apparatus can communicate. The apparatus of some embodiments is also caused to at least perform generating a response frame indicating the counteroffer based at least in part on the received frame and one or more current traffic demands of the apparatus; and transmitting the response frame to the STA.

The apparatus of some embodiments is also caused to at least perform receiving a second frame during the shared TXOP from the STA. In this embodiment, the second frame indicates an update to at least one of whether the apparatus can communicate during the shared TXOP with (a) the STA or (b) the STA and one or more other STAs, or the maximum duration of the shared TXOP during which the apparatus can communicate, or one or more permissible traffic types that can be communicated during the shared TXOP, or one or more permissible streams that can be communicated during the shared TXOP, or the second frame indicates a termination of the shared TXOP. The apparatus of some embodiment is also caused to at least perform configuring a sleep mode of the apparatus based at least in part on the minimum duration or the exact duration until the next shared TXOP instance. In this embodiment, the frame indicates a minimum duration or an exact duration until a next shared TXOP instance without being a TXOP offer.

The apparatus of some embodiments is also caused to at least perform generating a second frame; and transmitting the frame to the STA during an instance that is prior to the second shared TXOP. In this embodiment, the second frame is a request for a new shared TXOP. The apparatus of some embodiments is also caused to at least perform generating a second frame; and transmitting the second frame to the STA during the shared TXOP. In this embodiment, the second frame is a request indicating a termination of the TXOP. The apparatus of some embodiments includes an access point (AP) STA or a non-AP STA.

According to another aspect of the present disclosure, there is provided a method including: receiving, from a station (STA), a frame associated with a shared transmission opportunity (TXOP). The frame indicates at least one of (i) whether an apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

According to some embodiments, the frame includes at least two subfields encoded to indicate whether the apparatus can communicate during the shared TXOP with (a) the STA or (b) the STA and one or more other STAs. The at least two subfields of some embodiments include at least one of extended encodings of a reverse direction grant (RDG) subfield or extended encodings of an access category (AC) constraint subfield. The frame of some embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of some embodiments indicates the maximum duration of the shared TXOP during which the apparatus can communicate.

According to some embodiments, the frame indicates, via the RDG subfield and the AC constraint subfield, that the apparatus can communicate during the shared TXOP with only the STA. According to other embodiments, the frame indicates, via the RDG subfield and the AC constraint subfield, that the apparatus can communicate during the shared TXOP with the STA and one or more other STAs. The method of some embodiments further includes determining to not respond to the frame received from the STA. The method of some embodiments further includes generating, based at least in part on the frame received from the STA, a response frame; and transmitting the response frame to the STA. In this embodiment, the response frame indicates at least one of the following: that the shared TXOP is accepted, that the shared TXOP is not accepted, or a counteroffer. The counteroffer of some embodiments indicates at least one of a request to communicate with the STA, or a request to communicate with the STA and one or more other STAs, or one or more permissible traffic types to be communicated, or one or more permissible streams to be communicated, or a minimum duration of the shared TXOP during which the apparatus can communicate. The method of some embodiments further includes generating a response frame indicating the counteroffer based at least in part on the received frame and one or more current traffic demands of the apparatus; and transmitting the response frame to the STA.

The method of some embodiments further includes receiving a second frame during the shared TXOP from the STA. In this embodiment, the second frame indicates an update to at least one of whether the apparatus can communicate during the shared TXOP with (a) the STA or (b) the STA and one or more other STAs, or the maximum duration of the shared TXOP during which the apparatus can communicate, or one or more permissible traffic types that can be communicated during the shared TXOP, or one or more permissible streams that can be communicated during the shared TXOP, or the second frame indicates a termination of the shared TXOP. The method of some embodiments further includes configuring a sleep mode of the apparatus based at least in part on the minimum duration or the exact duration until the next shared TXOP instance. In this embodiment, the frame indicates a minimum duration or an exact duration until a next shared TXOP instance without being a TXOP offer.

The method of some embodiments further includes generating a second frame; and transmitting the frame to the STA during an instance that is prior to the new shared TXOP. In this embodiment, the second frame is a request for a new shared TXOP. The method of some embodiments further includes generating a second frame; and transmitting the second frame to the STA during the shared TXOP. In this embodiment, the second frame is a request indicating a termination of the TXOP. The apparatus of some embodiments includes an access point (AP) STA or a non-AP STA.

According to another aspect of the present disclosure, there is provided a computer program product, including at least one non-transitory computer-readable storage medium having computer-executable program code portions stored therein with the computer-executable program code portions comprising program code instructions configured to receive, from a station (STA), a frame associated with a shared transmission opportunity (TXOP). The frame indicates at least one of (i) whether an apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

According to some embodiments, the frame includes at least two subfields encoded to indicate whether the apparatus can communicate during the shared TXOP with (a) the STA or (b) the STA and one or more other STAs. The at least two subfields of some embodiments include at least one of extended encodings of a reverse direction grant (RDG) subfield or extended encodings of an access category (AC) constraint subfield. The frame of some embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of some embodiments indicates the maximum duration of the shared TXOP during which the apparatus can communicate.

According to some embodiments, the frame indicates, via the RDG subfield and the AC constraint subfield, that the apparatus can communicate during the shared TXOP with only the STA. According to other embodiments, the frame indicates, via the RDG subfield and the AC constraint subfield, that the apparatus can communicate during the shared TXOP with the STA and one or more other STAs. According to some embodiments the computer-executable program code portions include program code instructions configured to determine to not respond to the frame received from the STA. According to some embodiments the computer-executable program code portions include program code instructions configured to generate, based at least in part on the frame received from the STA, a response frame; and transmit the response frame to the STA. In this embodiment, the response frame indicates at least one of the following: that the shared TXOP is accepted, that the shared TXOP is not accepted, or a counteroffer. The counteroffer of some embodiments indicates at least one of a request to communicate with the STA, or a request to communicate with the STA and one or more other STAs, or one or more permissible traffic types to be communicated, or one or more permissible streams to be communicated, or a minimum duration of the shared TXOP during which the apparatus can communicate. According to some embodiments the computer-executable program code portions include program code instructions configured to generate a response frame indicating the counteroffer based at least in part on the received frame and one or more current traffic demands of the apparatus; and transmit the response frame to the STA.

According to some embodiments the computer-executable program code portions include program code instructions configured to receive a second frame during the shared TXOP from the STA. In this embodiment, the second frame indicates an update to at least one of whether the apparatus can communicate during the shared TXOP with (a) the STA or (b) the STA and one or more other STAs, or the maximum duration of the shared TXOP during which the apparatus can communicate, or one or more permissible traffic types that can be communicated during the shared TXOP, or one or more permissible streams that can be communicated during the shared TXOP, or the second frame indicates a termination of the shared TXOP. According to some embodiments the computer-executable program code portions include program code instructions configured to configure a sleep mode of the apparatus based at least in part on the minimum duration or the exact duration until the next shared TXOP instance. In this embodiment, the frame indicates a minimum duration or an exact duration until a next shared TXOP instance without being a TXOP offer.

According to some embodiments the computer-executable program code portions include program code instructions configured to generate a second frame; and transmitting the frame to the STA during an instance that is prior to the new shared TXOP. In this embodiment, the second frame is a request for a new shared TXOP. According to some embodiments the computer-executable program code portions include program code instructions configured to generate a second frame; and transmit the second frame to the STA during the shared TXOP. In this embodiment, the second frame is a request indicating a termination of the TXOP. The apparatus of some embodiments includes an access point (AP) STA or a non-AP STA.

According to another aspect of the present disclosure, there is provided an apparatus including means for receiving, from a station (STA), a frame associated with a shared transmission opportunity (TXOP). The frame indicates at least one of (i) whether the apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

According to some embodiments, the frame includes at least two subfields encoded to indicate whether the apparatus can communicate during the shared TXOP with (a) the STA or (b) the STA and one or more other STAs. The at least two subfields of some embodiments include at least one of extended encodings of a reverse direction grant (RDG) subfield or extended encodings of an access category (AC) constraint subfield. The frame of some embodiments includes at least one of a TXOP Sharing-Traffic Characteristics Indication (TXS-TCI) subfield or a TXOP Sharing-Duration (TXS-DU) subfield. The TXS-TCI subfield of some embodiments indicates at least one of the one or more permissible traffic types that can be communicated during the shared TXOP or the one or more permissible streams that can be communicated during the shared TXOP. The TXS-DU subfield of some embodiments indicates the maximum duration of the shared TXOP during which the apparatus can communicate.

According to some embodiments, the frame indicates, via the RDG subfield and the AC constraint subfield, that the apparatus can communicate during the shared TXOP with only the STA. According to other embodiments, the frame indicates, via the RDG subfield and the AC constraint subfield, that the apparatus can communicate during the shared TXOP with the STA and one or more other STAs. The apparatus of some embodiments also includes means for determining to not respond to the frame received from the STA. The apparatus of some embodiments also includes means for generating, based at least in part on the frame received from the STA, a response frame; and transmitting the response frame to the STA. In this embodiment, the response frame indicates at least one of the following: that the shared TXOP is accepted, that the shared TXOP is not accepted, or a counteroffer. The counteroffer of some embodiments indicates at least one of a request to communicate with the STA, or a request to communicate with the STA and one or more other STAs, or one or more permissible traffic types to be communicated, or one or more permissible streams to be communicated, or a minimum duration of the shared TXOP during which the apparatus can communicate. The apparatus of some embodiments also includes means for generating a response frame indicating the counteroffer based at least in part on the received frame and one or more current traffic demands of the apparatus; and transmitting the response frame to the STA.

The apparatus of some embodiments also includes means for receiving a second frame during the shared TXOP from the STA. In this embodiment, the second frame indicates an update to at least one of whether the apparatus can communicate during the shared TXOP with (a) the STA or (b) the STA and one or more other STAs, or the maximum duration of the shared TXOP during which the apparatus can communicate, or one or more permissible traffic types that can be communicated during the shared TXOP, or one or more permissible streams that can be communicated during the shared TXOP, or the second frame indicates a termination of the shared TXOP. The apparatus of some embodiment also includes means for configuring a sleep mode of the apparatus based at least in part on the minimum duration or the exact duration until the next shared TXOP instance. In this embodiment, the frame indicates a minimum duration or an exact duration until a next shared TXOP instance without being a TXOP offer.

The apparatus of some embodiments also includes means for generating a second frame; and means for transmitting the frame to the STA during an instance that is prior to the new shared TXOP. In this embodiment, the second frame is a request for a new shared TXOP. The apparatus of some embodiments also includes means for generating a second frame; and transmitting the second frame to the STA during the shared TXOP. In this embodiment, the second frame is a request indicating a termination of the TXOP. The apparatus of some embodiments includes an access point (AP) STA or a non-AP STA.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of an example communication system;

FIG. 2 is a block diagram of an apparatus that may be specifically configured in accordance with an example embodiment of the present disclosure;

FIG. 3 illustrates various example communication scenarios during a TXOP;

FIG. 4 illustrates an example operation of the RD protocol;

FIG. 5 illustrates another example operation of the RD protocol;

FIG. 6 illustrates a new subfield TXOP Sharing-Traffic Characteristics Indication in accordance with at least an example embodiment;

FIG. 7 depicts an example table including one or more extended encodings in accordance with some example embodiments;

FIG. 8 illustrates an example of how a TXOP Holder uses the TXS-DU subfield in the TSO frame to convey a duration of the shared TXOP in accordance with at least an example embodiment;

FIG. 9 illustrates an example where the TXOP Responder may solicit ACK/BA from the Holder during the shared TXOP instance in accordance with some example embodiments;

FIG. 10 illustrates an example where a STA uses the TXS-DU field in non-TSO frames to convey to one or more other STAs the time before the next TXOP sharing instance in accordance with at least an example embodiment;

FIG. 11 illustrates an example where the RD protocol cannot properly specify the permissible traffic types that can be exchanged during a TXOP;

FIG. 12 illustrates an example of some of the technical improvements of certain techniques described herein in accordance with at least an example embodiment;

FIG. 13 illustrates an example of enabling a TXOP Responder to communicate with Third-party STAs in accordance with at least some example embodiments;

FIG. 14 illustrates another example of enabling a TXOP Responder to communicate with Third-party STAs in accordance with at least some example embodiments;

FIG. 15 illustrates another example of enabling a TXOP Responder to communicate with Third-party STAs in accordance with at least some example embodiments;

FIG. 16 illustrates an example of encodings for the TXS-TCI subfield in accordance with at least an example embodiment;

FIG. 17 illustrates an example of a Responder making a request when sending an ACK/BA frame to the Holder in accordance with at least some example embodiments;

FIG. 18 illustrates another example of the TXOP Responder making requests for TXOP sharing in accordance with at least some example embodiments;

FIG. 19 illustrates an example of a counteroffer sent via BA or other types of PPDUs in accordance with at least an example embodiment;

FIG. 20 illustrates the operations performed, such as by the apparatus of FIG. 2, in accordance with at least some example embodiments; and

FIG. 21 illustrates the operations performed, such as by the apparatus of FIG. 2, in accordance with at least some example embodiments.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with example embodiments of the present disclosure. Thus, use of any such terms should not be taken to limit the spirit and scope of example embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

A communications system may be deployed in a wireless local area network (e.g., WLAN, Wi-Fi, etc.), for example, based on IEEE 802.11 standards and/or related drafts, such as 802.11-2020, 802.11ac, 802.11ax, 802.11be, 802.11bn, and/or others. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about 2.4 GHz radio frequency band and/or about 5 GHz radio frequency band. In some such examples, each radio frequency band may support one or more channels over which data may be communicated. In some examples, multiple devices may use multiple channels to communicate over the WLAN simultaneously.

A WLAN system may include one or more communications devices, such as one or more access points (APs) and/or one or more non-AP stations (STAs). That is, a device configured to support one or more Wi-Fi protocols may be an example of an AP (e.g., may operate in accordance with an AP mode) and/or may be an example of a STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity which may be configured to act as a network manager. In some examples, the network manager is an entity in cloud-based entity which may reside either in private cloud or in public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more non-AP STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDUs, wherein a payload of a PDU may comprise user data, control data, management data, and/or other data. In some examples, a WLAN system may implement one or more security protocols to protect the confidentiality, integrity, and availability of Wi-Fi communications.

A transmission opportunity (TXOP) is a MAC feature in IEEE 802.11. TXOPs are also features in other standards. TXOPs are configured to increase throughput, such as for high priority data, by providing contention-free channel access for a period of time. A TXOP may be available in a quality of service (QOS) mode as part of Enhanced Distributed Channel Access (EDCA), and/or may be a limited time period of contention-free channel access available to the channel-owning station (e.g., the TXOP Holder). During such a period the TXOP Holder, which may be a non-AP STA or an AP, may send multiple frames that meet criteria that may have been determined for the use of TXOP. In some examples, the criteria may allow transmission of frames belonging to an access category (AC) other than the AC for which the TXOP has been obtained. An advantage of a TXOP is that it may increase throughput and/or reduce delay of QoS data frames by eliminating contention periods between transmissions. TXOP may be used in combination with aggregation and block acknowledgement to further increase throughput.

In some examples, access categories have different channel access parameters, for example, such as Arbitration Interframe Spacing (AIFS), duration, contention window size, and TXOP limit. In an example, as part of the EDCA parameters of the IEEE 802.11 standard, these values are set so that higher priority packets are favored (e.g., the non-AP STA waits less before sending them, the contention window is smaller, multiple packets can be sent in a TXOP, etc.). In some examples, a TXOP Holder which may be either non-AP STA or an AP may send frames to multiple recipients during a TXOP. In addition to QoS data frames, other frames can be exchanged in the course of the TXOP, such as ACK and BlockAckReq/BlockAck frames, and/or other control and management frames.

A WLAN system may comprise at least one STA. An AP of a WLAN system may comprise at least one STA and/or at least one distribution system access function configured to facilitate data communication beyond the AP. Additionally or alternatively, non-AP STAs may be configured to be end devices which rely on association with an AP to communicate with devices other than the AP. An AP may be configured to connect to a wired LAN (e.g., via Ethernet). The AP may allow one or more client devices (e.g., non-AP STAs) to access wireless connections via WLAN. The client devices may also be referred to as “WLAN clients”. WLAN clients may comprise various devices and/or types of devices, including laptops, tablets, cell phones, and/or other devices.

A WLAN system may further rely on multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP which supports MLO may be referred to as an AP multi-link device (MLD). An MLO-capable client, for example, such as a non-AP STA, may be referred to as a non-AP MLD. Such a client device may have two or more STAs with which it may establish links to an AP MLD. A STA-AP connection may represent a link between an AP MLD and a non-AP MLD. In some examples, APs which do not support MLO may be multi-band APs which have two or more APs operating in different bands and/or channels. Such an AP may operate, for example, in 2.4 GHz and/or in 5 GHz bands, wherein a client device may connect to the AP via any of the bands and/or channels. For example, a client device may associate to the AP in one of the channels. An AP MLD may perform like a multi-band AP while providing means for a multi-link capable client (non-AP MLD) to simultaneously use two or more of its radios and/or APs for communication with single association. An AP MLD may be an MLMR which is configured to communicate simultaneously with its APs with associated non-AP MLDs. Non-AP MLDs may have restrictions (e.g., NSTR) which may mean that simultaneous communication over established links may not be possible. Therefore, a non-AP MLD may associate to an AP MLD, meaning the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with E-MAR may be configured to allow client devices to switch between a plurality of respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common PHY medium access characteristics (e.g., radio frequency, modulation scheme, security settings, and/or the like). A BSS identifier (BSSID) may define the BSS such that the one or more client devices of the BSS share the same BSSID.

In some examples, two or more BSSs may have overlapping coverage areas and they may operate with either partially or entirely same radio frequency channels. In such examples of overlapping BSSs (OBSSs), a client device may transmit frames from the area of overlap; other client devices may sense the transmission. Responsive to sensing the transmission, the other client devices may cease their own transmissions. In some examples, if the other client devices do not sense the transmission, the other client devices may become hidden terminals with respect to the client device which is transmitting.

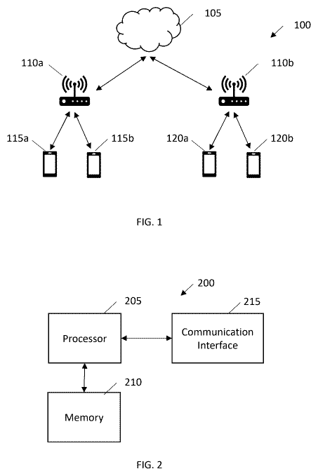

One example of a communications system 100 in which an example embodiment may be deployed is depicted in FIG. 1. The communications system 100 may be utilized for a variety of applications. For example, the communications system 100 may include at least one cloud network 105, at least one AP such as the APs 110a and 110b (collectively “110”), at least one client device (e.g., non-AP STA) such as the client devices 115a and 115b (collectively “115”) connected to the AP 110a and the client devices 120a and 120b (collectively “120”) connected to the AP 110b, and/or other components. The APs 110 may be mobile access points (mAPs) with limited functionality. In some examples, a configuration comprising a mAP and a client device may be implemented as part of a peer-to-peer connection, for example, as in Wi-Fi Direct. In some examples, a device is able to simultaneously operate as client device and as an AP. One such an example case is a multi-AP network which comprises of two or more devices which act as APs and use Wi-Fi for the wireless backhaul connectivity based on the non-AP STA-AP connection model.

Wireless communication systems may include access points that provide wireless connectivity according to the Wi-Fi standards, which are a subset of the IEEE 802 family of standards. For example, the medium access control (MAC) and physical layer (PHY) specifications for Wi-Fi access points are defined by IEEE 802.11 for transmitting and receiving data in frequency bands such as 2.4 gigahertz (GHz), 3.6 GHz, 5 GHz, 6 GHz, 60 GHz, and/or the like. Wi-Fi access points may transmit one or more frames. For example, the one or more frames may include data frames, management frames, and/or control frames, which may be transmitted in unicast messages, broadcast messages, or multicast messages. The 802.11 standards define an inter-frame space (IFS) as the nominal time (in microseconds, us) that the MAC and PHY require in order to receive the last symbol of a frame, process the frame, and respond with the first symbol of the earliest possible response frame.

In FIG. 1, client devices 115 and/or 120 are configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, user equipment (UEs), and/or other entities suitable for such usage.

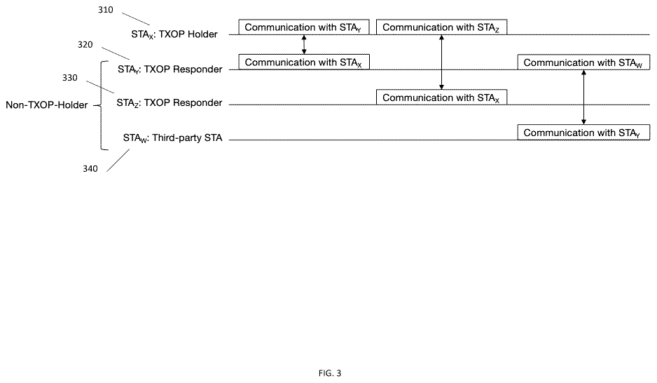

In some examples, the communications system 100 may support radiofrequency sensing during IFS. In some examples, the communications system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The network manager may include a processor and/or a memory (e.g., such as a processor 205 and/or a memory 210, further described with respect to FIG. 2). The processor 205 may be used to execute instructions stored in the memory 210 and/or to store information in the memory 210, for example, such as the results of the executed instructions.

The Wi-Fi APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver.

An apparatus 200 may be implemented by a user device to which resources on the access interface are allocated and assigned, and thus any feature described herein with a user device may be implemented with a corresponding apparatus, such as the apparatus 200. The Wi-Fi AP 110 may further include a processor (e.g., such as the processor 205) and a memory (e.g., such as the memory 210). The processor 205 may be used to execute instructions stored in the memory 210 and/or to store information in the memory 210, for example, such as the results of the executed instructions.

The apparatus 200 may be configured to function as the cloud network 105, APs 110, client devices 115 and/or 120, and/or other entities. As shown in FIG. 2, the apparatus includes, is associated with, and/or is in communication with: a processor 205, a memory 210, and a communication interface 215. The processor 205 may be in communication with the memory device 210 via a bus for passing information among components of the apparatus 200. The memory device 210 may be non-transitory and may include, for example, one or more volatile and/or non-volatile memories. In other words, for example, the memory device 210 may be an electronic storage device (e.g., a computer readable storage medium) comprising gates configured to store data (e.g., bits) that may be retrievable by a machine (e.g., a computing device like the processor). The memory device 210 may be configured to store information, data, content, applications, instructions, or the like for enabling the apparatus to carry out various functions in accordance with an example embodiment of the present disclosure. For example, the memory device 210 could be configured to buffer input data for processing by the processor. Additionally or alternatively, the memory device 210 may be configured to store instructions for execution by the processor 205.

FIG. 2 depicts an example of a simplified block diagram of an apparatus according to various embodiments of the present disclosure, whose implementation may differ from what is shown. The connections shown in FIG. 2 are logical connections; the actual physical connections may be different. It is apparent to a person skilled in the art that the system typically comprises also other functions and structures than those shown in FIG. 2.

The apparatus 200 may, in some embodiments, be embodied in various computing or communication devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single system on a chip (SOC). As such, in some cases, a chip or chipset may constitute means for performing one or more operations for providing the functionalities described herein.

The processor 205 may be embodied in a number of different ways. For example, the processor 205 may be implemented by processing circuitry. For example, the processor 205 may be embodied as one or more of various hardware processing means such as a coprocessor, a microprocessor, a controller, a digital signal processor (DSP), a processing element with or without an accompanying DSP, or various other circuitry including integrated circuits such as, for example, an application specific integrated circuit (ASIC), a field programmable gate array (FPGA), a microcontroller unit (MCU), a hardware accelerator, a special-purpose computer chip, and/or the like. As such, in some embodiments, the processor 205 may include one or more processing cores configured to perform independently. A multi-core processor may enable multiprocessing within a single physical package. Additionally or alternatively, the processor 205 may include one or more processors configured in tandem via the bus to enable independent execution of instructions, pipelining and/or multithreading.

In an example embodiment, the processor 205 may be configured to execute instructions stored in the memory device 210 or otherwise accessible to the processor 205. Alternatively or additionally, the processor 205 may be configured to execute hard coded functionality. As such, whether configured by hardware or software methods, or by a combination thereof, the processor 205 may represent an entity (e.g., physically embodied in circuitry) capable of performing operations according to an embodiment of the present disclosure while configured accordingly. Thus, for example, when the processor 205 is embodied as an ASIC, FPGA, and/or the like, the processor 205 may be specifically configured hardware for conducting the operations described herein. Alternatively or additionally, as another example, when the processor 205 is embodied as an executor of instructions, the instructions may specifically configure the processor to perform the algorithms and/or operations described herein when the instructions are executed. However, in some cases, the processor 205 may be a processor of a specific device (e.g., an image or video processing system) configured to employ an embodiment of the present disclosure by further configuration of the processor by instructions for performing the algorithms and/or operations described herein. The processor 205 may include, among other things, a clock, an arithmetic logic unit (ALU), and/or logic gates configured to support operation of the processor 205.

The communication interface 215 may be a device and/or circuitry embodied in either hardware or a combination of hardware and software that is configured to receive and/or transmit data, including media content in the form of video or image files, one or more audio tracks, and/or the like. In this regard, the communication interface 215 may include, for example, an antenna (or multiple antennas) and supporting hardware and/or software for enabling communications with a wireless communication network. Additionally or alternatively, the communication interface 215 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some examples, the apparatus 200 may be an access point (AP) or a non-AP station (STA) (e.g., such as a client device) usable in a Wi-Fi network operating in accordance with wireless standards (e.g., IEEE 802.11 standards). In some examples, a transmission opportunity (TXOP) may be a time interval during which a station (STA), which could be either an access point (AP) or a non-AP STA, has the right to initiate transmissions via a wireless medium. In some examples, a TXOP Holder may be a STA that has gained the right to access the wireless medium for a certain period. In some examples, a preemption opportunity (PO) may be a specific time interval within a TXOP during which some STAs other than the TXOP Holder are allowed to contend for channel access. In some examples, an access category (AC) may be a classification used to prioritize different types of traffic within a network. In some examples, an AC may be referred to as a priority and/or priority level. In some examples, at least one AC (e.g., each AC) may have a unique priority level.

In some examples, a TXOP Holder may be a STA that wins a channel (e.g., using EDCAF) and reserves a TXOP for a certain duration to communicate with one or more TXOP Responders. A TXOP Responder may be, for example, any peer STA that engages in communication with the TXOP Holder during the reserved TXOP. In certain examples, any STA except for the TXOP Holder and TXOP Responder may be a Third-party STA. Any STA other than the TXOP, in some examples, may be a non-TXOP Holder STA. For example, TXOP Responders and Third-party STAs may be considered non-TXOP Holder STAs.

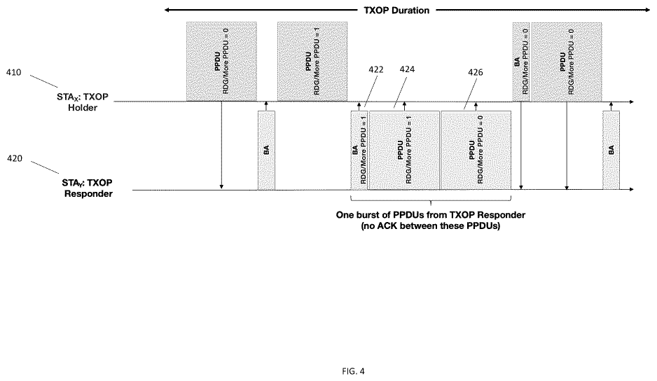

FIG. 3 illustrates various example communication scenarios during a TXOP. A TXOP Holder 310 may communicate with one or more TXOP Responders 320 and 330. The TXOP Responder 320 may communicate with one or more Third-party STAs such as Third-party STA 340. As used herein, the terms TXOP Holder or Holder may be used interchangeably. As used herein, the terms TXOP Responder or Responder may be used interchangeably.

Various embodiments described herein provide technical improvements to the reverse direction (RD) protocol. The RD protocol is a feature included in the IEEE 802.11e amendment. RD allows for bidirectional data transfer during a TXOP, thereby helping to reduce channel access overhead and improve the efficiency of data exchange. In some cases, when a TXOP Holder (e.g., STA 310) sends data to a TXOP Responder (e.g., STA 320 or 330), the TXOP Responder needs to content for the wireless medium to send a response. With RD, once a TXOP Holder has gained access to the medium (E.g., using EDCA or HCF Controlled Channel Access) and reserves the medium, it can send data, and then delegate transmission rights to a TXOP Responder to send its response within the same TXOP, without needing the TXOP Holder to release the channel. This reduces the contention overhead, minimizes latency, and improves overall throughput. This works by setting the Reverse Direction Grant (RDG) subfield in the MAX header. If the TXOP Holder allows RD via setting RDG, a TXOP Responder can immediately respond with its own data frames, maximizing channel usage by reducing the need for recontending for the medium. The RDG bit is set in the HT Control field of a data frame.

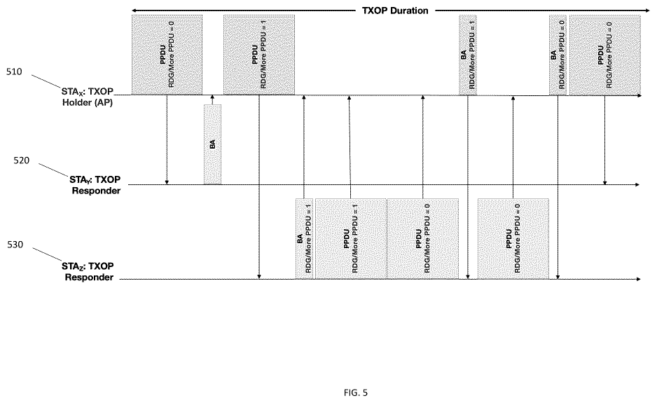

FIG. 4 illustrates an example operation of the RD protocol where a TXOP Holder exchanges bidirectional traffic with a TXOP Responder. As shown, a TXOP Holder 410 exchanges bidirectional traffic with a TXOP Responder 420. The bidirectional communication between the TXOP Holder 410 and the TXOP Responder 420 is per the 802.11ax and/or the 802.11be standards (also herein collectively referred to as 802.11ax/be standards). For example, while sending frames to the TXOP Holder 410, the TXOP Responder 420 sets the RDG flag to 1 as shown in frames 422 and 424, except for the last frame 426, where the TXOP Responder 420 sets the RDG flag to 0 to convey the end of transmission from the TXOP Responder 420 to the TXOP Holder 410.

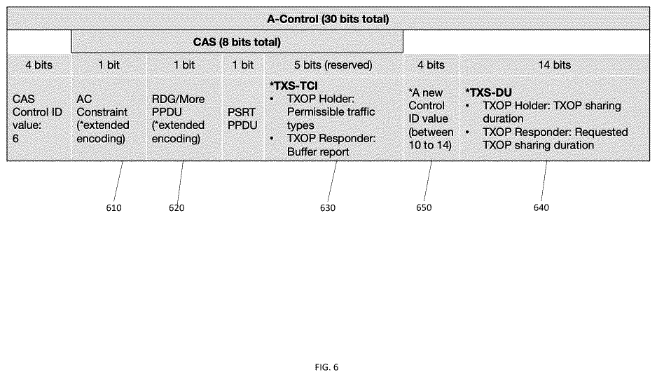

FIG. 5 illustrates another example operation of the RD protocol where a TXOP Holder exchanges bidirectional traffic with two TXOP Responders. As shown, a TXOP Holder 510 is an access point (AP). The TXOP Holder 510 may communicate with one or more TXOP Responders 520 and 530. The RD protocol in the 802.11ax/be standard allow a TXOP Holder (e.g., TXOP Holder 510) to communicate with one or more TXOP Responders (e.g., TXOP Responder 520 and TXOP Responder 530).

Some of the advantages of RD are as follows: (1) reduced latency: by eliminating the need for the receiving STA to contend again for the channel, RD significantly reduces the latency of transmitting data in both directions; (2) increased throughput: the protocol increases throughput by reducing the overhead associated with contention, especially in environments where both sides of communication need to frequently exchange data; (3) better QoS: the protocol helps improve QoS for applications that require efficient bidirectional communication, such as video calls, Voice over Internet Protocol (VOIP), gaming, and AR/VR/XR; (4) efficient use of TXOP: the RD protocol allows better utilization of the TXOP, maximizing the amount of data that can be exchanged while minimizing wasted airtime.

Various works are directed to developing the RD protocol. For example, [IEEE Mentor website: 802.11-23/1387r0] proposes TXOP optimizations to facilitate bidirectional data exchange during a TXOP, such as in TCP flows, suggesting that any station (STA) should be capable of sharing its TXOP with minimal overhead to meet XR requirements.

[IEEE Mentor website: 802.11-23/1874r0] introduces reverse TXOP sharing, where non-AP STAs can share the remaining unused TXOP time with the access point (AP). This allows the AP to utilize the remaining TXOP to either send DL traffic or schedule UL transmissions for other non-AP STAs, thus improving channel efficiency and responsiveness. Additionally, the STA provides the AP with information regarding the remaining TXOP time, and the AC used to acquire the TXOP, enabling prioritization of latency-sensitive traffic.

[U.S. Pat. No. 9,655,136B2] introduces a method that enables a STA to transfer unused TXOP time to the AP. The AP can use the remaining TXOP time to send data to multiple STAs simultaneously, leveraging multi-user, multiple-input, multiple-output (MU-MIMO) technology. This approach further enhances channel efficiency and is particularly beneficial for DL-heavy traffic situations.

However, the traditional RD protocol in 802.11ax and 802.11be standards, as well as previous works, have limitations that necessitate an enhancement to the protocol. The present disclosure proposes an enhanced RD protocol that includes, but is not limited to, the following key technical improvements and features: Flexible TXOP sharing: The TXOP Holder can share any portion of its TXOP at any time, allowing for greater flexibility in resource allocation; Control over shared TXOP duration: The TXOP Holder can control the duration of shared TXOP instances, providing a more granular level of management; Traffic type and stream control: The TXOP Holder can specify the traffic types and streams that can be exchanged during shared TXOP instances, ensuring more targeted and efficient communication; Third-party STA access: The proposed protocol enables sharing a TXOP instance with a Responder and allowing the Responder to communicate with Third-party STAs during the shared instance, expanding the scope of communication; TXOP sharing requests: A TXOP Responder can now request from the TXOP Holder for TXOP sharing, providing a more direct and efficient means of resource allocation; Counteroffer capability: A TXOP Responder can provide the TXOP Holder with counteroffers on the TXOP sharing offers, enabling a more dynamic and responsive negotiation process.

Certain embodiments of the present disclosure are directed to providing technical improvements to the RD protocol by introducing new fields and extending the encoding of some existing fields. At least some embodiments of the present disclosure enhance the existing RD protocol available in the 802.11ax/be standards by introducing new fields in the MAC header and extending the encoding of some existing fields. The proposed changes maintain backward compatibility with the existing RD protocol in the 802.11ax and 802.11be standards.

The latest 802.11ax/be standards use the Command and Status (CAS) subfield within the A-Control subfield to convey the information related to the RD protocol. The CAS subfield includes an access category (AC) Constraint and RDG/More physical protocol data unit (PPDU) bits.

Some embodiments described herein use extended joint encoding (sometimes referred to herein as extended encodings or encodings) of the RDG/More PPDU and the AC Constraint bits/subfields. In the traditional RD protocol, the RDG/More PPDU bit is used to convey to a TXOP Responder that it can perform transmissions to the TXOP Holder. However, in various embodiments of the present disclosure, a more nuanced approach is employed by extending to a joint encoding of the RDG/More PPDU and the AC Constraint subfields. By leveraging the extended encoding described herein, the present disclosure provides more efficient and flexible TXOP sharing mechanisms.

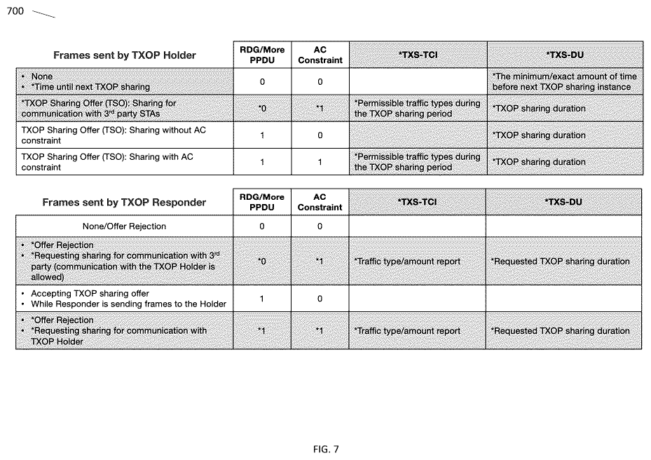

Various embodiments described herein use a new subfield which may be referred to as TXOP Sharing-Traffic Characteristics Indication (TXS-TCI). An example embodiment of this subfield is illustrated in FIG. 6, where one or more of the 5 reserved bits of the CAS subfield may be used to represent the TXS-TCI subfield. In some embodiments, the TXS-TCI subfield may convey one or more different meanings, depending on the transmitter of the frame including this field.

Certain embodiments described herein use a new subfield, which may be referred to as TXOP Sharing-Duration (TXS-DU). An example embodiment of this subfield is illustrated in FIG. 4, where one or more of the 18 remaining bits (not used by CAS subfield) of the A-Control subfield may be used to represent the TXS-DU subfield and its corresponding Control ID value. In some embodiments, the TXS-DU subfield may convey one or more different meanings, depending on the transmitter of the frame including this field.

FIG. 6 illustrates how the 802.11ax/be standards encode the AC Constraint and RDG/More PPDU subfields in the CAS subfield, as well as various new subfields of the present disclosure. In some embodiments, the encodings of the AC Constraint and RDG/More PPDU subfields are extended as shown at 610 and 620. Various embodiments include the TXS-TCI subfield 630 and the TXS-DU subfield 640, which may be used by the TXOP Holder and TXOP Responder to manage one or more TXOP sharing parameters. Additionally, some embodiments include a Control ID value corresponding to the TXS-DU as shown at 650. As illustrated in FIG. 6, items marked with * are newly proposed features of the present disclosure.

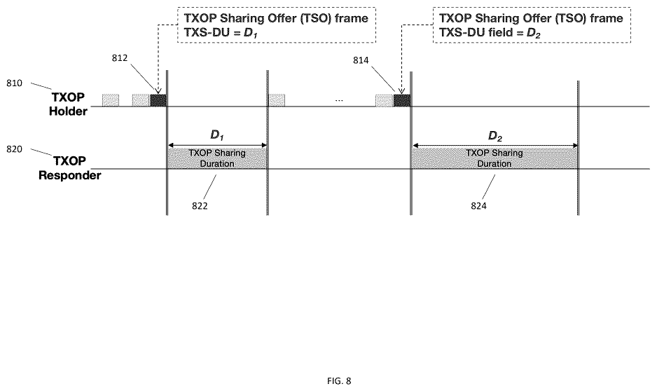

FIG. 7 illustrates an example table 700 including one or more extended encodings for the AC Constraint and RDG/More PPDU subfields, as well as an example of information that may be conveyed by the TXS-TCI and TXS-DU subfields disclosed herein. As illustrated in FIG. 7, items marked with * are newly proposed features of the present disclosure.

The contributions explained in the rest of the present disclosure rely on the subfields introduced in FIGS. 6 and 7 to achieve one or more of the various technical improvements provided herein. Instead of using the RDG/More PPDU, AC Constraint, TXS-TCI, and TSX-DU subfields as separate subfields, some embodiments, may integrate one or more of these fields into one. Such embodiments may require fewer Control ID bits within the A-Control field, allowing more bits to be used for signaling.

Some embodiments described herein are directed to providing technical improvements to the RD protocol by enabling controlling when and/or for how long the TXOP is shared.

In some embodiments, an offer for TXOP sharing may be made associated with a specific duration. To offer TXOP sharing to a TXOP Responder, the TXOP Holder may send a TXOP Sharing Offer (TSO) frame. The TSO may be a PPDU with specific fields indicating the type of sharing, and the Responder may accept the offer, decline the offer, or make a counteroffer. The Holder may use the TSO frame to convey the maximum duration of the sharing period. In some embodiments, the maximum duration of the sharing period may be indicated by a specific subfield, for example, the TXS-DU subfield.

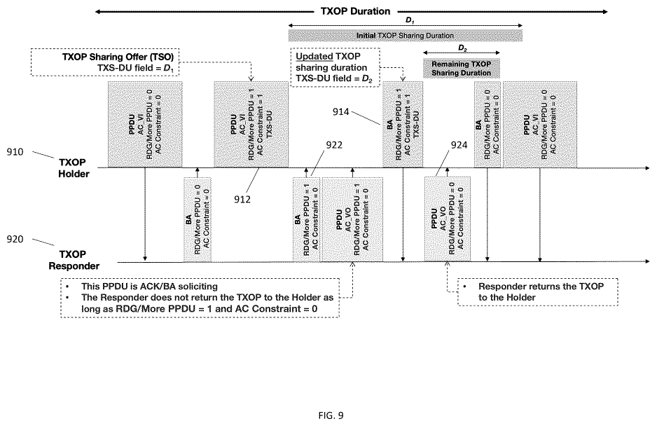

FIG. 8 illustrates an example of how a TXOP Holder 810 uses the TXS-DU subfield in the TSO frame 812 to convey a duration of the shared TXOP (D₁). The TXOP Responder 820 may use the entire or part of the TXOP Sharing Duration 822. Similarly, the TXOP Holder 810 uses the TXS-DU subfield in the TSO frame 814 to convey a duration of another shared TXOP (D₂) and the TXOP Responder 820 may use the entire or part of the TXOP Sharing Duration 824. An example allocation of the bits for the TXS-DU subfield is illustrated in FIG. 6, where the 18 unused bits of the A-Control subfield may be used to represent a Control ID and the value of the TXS-DU subfield.

Various embodiments support Acknowledgement (ACK) soliciting transmissions by TXOP Responders. In the RD protocol, as specified in the 802.11ax and 802.11be standards, a Responder must use RDG/More PPDU=1 as long as it will send additional frames to the TXOP Holder. Additionally, in the RD protocol, a Responder cannot request ACK/Block Acknowledgment (BA) frames from the Holder unless it sends its last PPDU to the Holder.

In contrast, various embodiments of the enhanced RD protocol disclosed herein eliminate this restriction. For example, in some embodiments, since the duration of TXOP sharing is announced by the TXOP Holder, such embodiments do not prevent the Responder from requesting ACK/BA during the shared TXOP. In some examples, if RDG/More PPDU=1 and AC Constraint=0, a Responder may send frames to the TXOP Holder, where PPDUs may solicit ACK/BA. Accordingly, in various embodiments, the Responder may request ACK/BA frames at any time during the shared TXOP, without having to terminate the shared TXOP.

Certain embodiments described herein provide for termination of a TXOP sharing instance by the TXOP Holder. For example, in various embodiments, if the values of RDG/More PPDU and AC Constraint bits in the ACK/BA frames sent from the Holder to the Responder are the same as those used for the TXOP sharing offer of the ongoing sharing instance, the Responder may stay in charge of the TXOP. Additionally, in some embodiments, if the Holder responds with an ACK/BA (or other frame types) where RDG/More PPDU=0 and AC Constraint=0, the Holder may indicate termination of the sharing instance.

Some embodiments described herein provide for dynamic adjustment of TXOP sharing duration. For example, in certain embodiments, if the values of RDG/More PPDU and AC Constraint bits in the ACK/BA frames sent from the Holder to the Responder are the same as those used for the TXOP sharing offer of the ongoing sharing instance, the TXOP sharing instance may continue. Such frames may also, in some examples, include the TXS-DU subfield, where the value of this subfield may indicate the remaining time of the current TXOP sharing instance as per the TXOP offer frame, or, in various examples, the TXOP Holder may use updated values to increase or reduce the remaining duration of the ongoing sharing instance.

In various embodiments, if a TXOP Responder uses a shared instance such that there is enough time left to return the TXOP to the Holder, the TXOP Responder may explicitly return the TXOP to the Holder. Accordingly, in some embodiments, the Responder may use the combination RDG/More PPDU=0 and AC Constraint=0, as per the original RD protocol operation. Additionally or alternatively, in certain embodiments, if a TXOP Responder uses a shared duration such that it leaves enough time to return the TXOP to the Holder, but the TXOP Responder does not return the TXOP to the Holder explicitly, the Holder may take control of the TXOP when the sharing period expires. Additionally or alternatively, in some embodiments, if a TXOP Responder uses the shared duration such that there is not enough time left to return the TXOP to the Holder (e.g., subject to the TXOP sharing duration), the TXOP Responder may be responsible for proper termination of the TXOP, as per the existing 802.11ax/be standard. In various embodiments, the TXOP Responder may explicitly return the TXOP to the Holder if the shared duration is not entirely used.

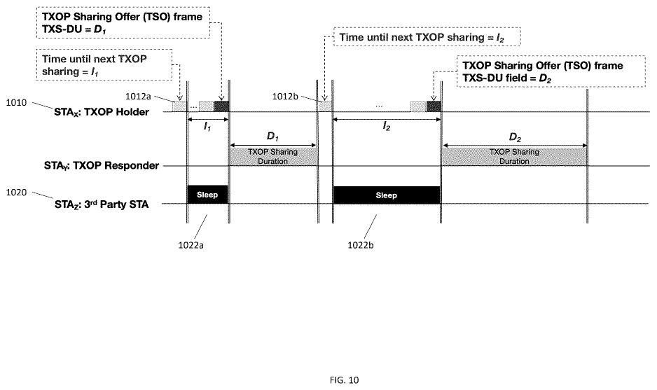

FIG. 9 illustrates an example where the TXOP Responder may solicit ACK/BA from the Holder during the shared TXOP instance. FIG. 9 further illustrates dynamic adjustment of TXOP sharing instance.

A TXOP Holder 910 sends an offer 912 to the TXOP Responder 920. The TXOP Responder 920 accepts the offer 912 from the TXOP Holder 910 by sending a PPDU 922 where RDG/More PPDU=1 and AC Constraint=0. If RDG/More PPDU=1 and AC Constraint=0 in the frames sent by the TXOP Responder 920, the shared TXOP is continued (while not exceeding the TXOP sharing duration D₁). The TXOP Responder 920 may solicit ACK/BA from the TXOP Holder 910 during the shared TXOP. During the TXOP sharing instance, the BA 914 sent from the Holder 910 to the TXOP Responder 920 uses RDG/More PPDU=1 and AC Constraint=1, indicating that the TXOP sharing instance may be continued. However, the BA 914 includes the TXS-DU subfield, specifying a new, shorter duration (D₂) for the TXOP sharing instance. The TXOP Responder 920 returns the TXOP to the TXOP Holder 910 by setting RDG/More PPDU=0 and AC Constraint=0 in the frame 924 before the updated TXOP sharing duration (D₂) expires.

Various embodiments provide for informing STAs about the duration until next sharing instance. For example, the PPDUs transmitted by a TXOP Holder may convey specific timing information regarding the duration until the next TXOP sharing instance. In some embodiments, in non-TSO PPDUs, the Holder may include the TXS-DU subfield, which may serve as a precise indicator of the minimum or an exact duration until the next sharing opportunity. Accordingly, some embodiments described herein provide technical improvements to STAs that are not currently involved in communication with the Holder, by enabling them, such as STAs that do not receive the offer but that instead overhear the offer, to proactively switch to sleep mode or execute alternative communication methods (e.g., peer-to-peer (P2P)) for low latency (LL) traffic exchange, if necessary.

As used herein, a non-TSO frame may refer to any frame where RDG/More PPDU=0 and AC Constraint=0. Alternatively, a non-TSO frame may simply exclude the CAS subfield.

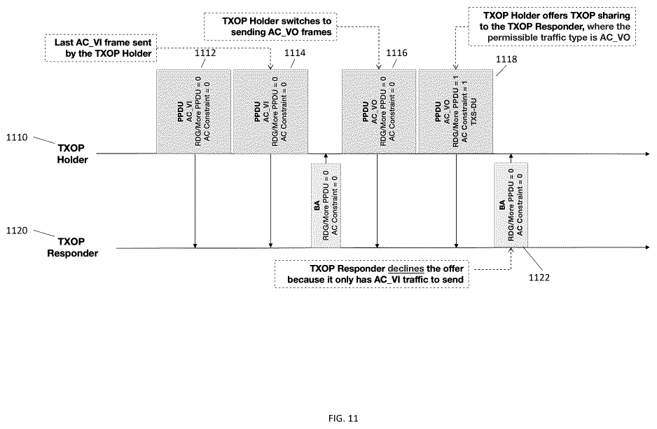

FIG. 10 illustrates an example where a STA uses the TXS-DU field in non-TSO frames to convey to one or more other STAs the time before the next TXOP sharing instance. For example, the TXOP Holder 1010 includes the TXS-DU field in non-TSO frames 1012a and 1012b to convey the durations 1022a and 1022b until the next TXOP sharing instance, respectively. Consequently, the Third-party STAz 1020 unable to participate in communication with the TXOP Holder 1010 during the durations 1022a and 1022b may take advantage of sleep mode. Accordingly, as shown, third party STAz switches to sleep mode during the durations 1022a and 1022b until the next TXOP sharing instances, respectively.

Certain embodiments described herein provide technical improvements to the RD protocol by enhancing constraints on permissible traffic types in shared TXOPs.

In the RD protocol (802.11ax/be) the AC Constraint subfield (1 bit) ensures that Responders respect quality of service (QOS) priorities during bidirectional communication. When AC Constraint bit is 1, for non-HE Responders (e.g., pre-802.11ax), the Responder must transmit data using the same Access Category (AC) as the last frame received from the RD initiator, ensuring consistency in QoS levels. In contrast, High-Efficiency (HE) Responders (802.11ax and newer) can send data from multiple AC queues, but only from those with priorities equal to or higher than the lowest priority AC of the MPDU(s) in the last PPDU received. This method of the RD protocol, however, introduces some shortcomings.

FIG. 11 illustrates an example where the RD protocol cannot properly specify the permissible traffic types that can be exchanged during a TXOP. The TXOP Holder 1110 first acquires the TXOP and transmits all frames 1112 and 1114 belonging to AC video (AC_VI). The TXOP Holder 1110 then sends its buffered traffic 1116 belonging to AC voice (AC_VO). Since the AC of the TSO frame 1118 (e.g., the frame offering TXOP sharing) is now AC_VO, the TXOP Responder 1120 is informed that only traffic belonging to AC_VO (or higher) can be sent in response. However, the TXOP Responder 1120 needs to send AC_VI traffic, which has a lower priority than AC_VO. Since the transmission of this traffic type is not allowed, the TXOP Responder 1120 declines the offer in frame 1122. Accordingly, it is a shortcoming of the traditional RD protocol (in 802.11ax/be) to specify the permissible traffic types that can be exchanged during a shared TXOP. The TXOP Responder 1120 declines the offer because the AC of the TSO frame 1118 is AC_VO while the TXOP Responder 1120 needs to send AC_VI frames.

Certain embodiments described herein provide technical improvements to the RD protocol by specifying traffic types. For example, some embodiments described herein enhance the operation of the RD protocol by specifying the permissible traffic types that may be exchanged during a shared TXOP. In some examples, after a last data frame is sent to a TXOP Responder, the TXOP Holder may send a null data packet (NDP) frame to convey a TSO with an AC value of ACx, thereby enabling the Responder to exchange traffic types equal to or higher than ACx during shared TXOPs. In certain examples, to avoid the transmission of an NDP, the Holder can use an artificially adjusted AC value for the last data frame sent to the TXOP Responder, effectively overriding any pre-set AC value.

In some embodiments, the TXS-TCI subfield may be used to enhance the control over permissible traffic types during shared TXOP instances. An example allocation of the bits for the TXS-TCI subfield is presented in FIG. 6, where the 5 reserved bits of the CAS subfield are used to represent this subfield.

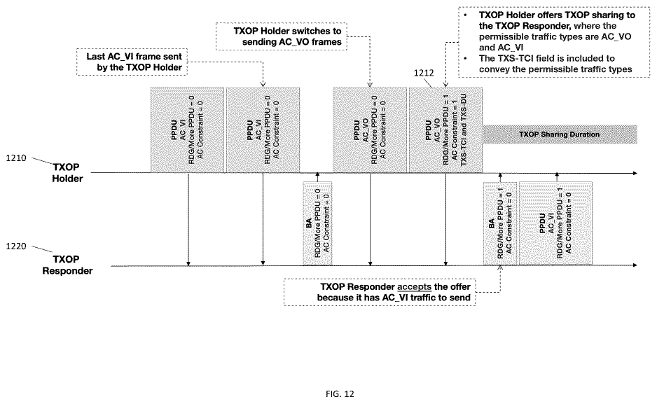

FIG. 12 illustrates an example of some of the technical improvements of certain techniques described herein. Even though the AC of the TSO frame 1212 is AC_VO, the TXOP Holder 1210 uses the TXS-TCI subfield to indicate the permissible traffic types and/or streams that can be exchanged during the shared TXOP. In particular, the TXOP Responder 1220 no longer relies on the AC of the TSO frame 1212 to determine the permissible traffic types, instead, the TXOP Responder 1220 evaluates the TXS-TCI subfield to determine the permissible traffic types. If the TXOP Responder 1220 determines that it can transmit one or more frames, it may accept the sharing offer, otherwise, the offer may be declined, or a counteroffer may be made. As shown, even though the AC of the TSO frame 1212 is AC_VO, the TXOP Responder 1220 accepts the offer because the TXS-TCI field allows sending AC_VI traffic and the TXOP Responder 1220 has AC_VI traffic to send.

The RD protocol allows the TXOP Holder to communicate with one or more Responders. However, the protocol does not allow the Responder to communicate with Third-party STAs. Some embodiments described herein provide technical improvements to the RD protocol by enabling the TXOP Holder to allow the TXOP Responder to communicate with Third-party STAs.

The following example scenarios justify the importance of allowing a Responder to communicate with Third-party STAs.

Scenario 1: The TXOP Holder transmits a plurality of frames to the Responder and requires the Responder to relay one or more of these frames to a Third-party STA. To facilitate this, the TXOP Holder grants permission to the Responder to communicate with Third-party STAs. In some cases, the TXOP Holder may specify which particular stream the Responder is allowed to send or which specific Third-party STA the Responder is allowed to communicate with, allowing for more controlled and efficient data forwarding within the TXOP.

Scenario 2: The TXOP Holder reserves the TXOP for 5 milliseconds to send AC_VI traffic but runs out of data to send after 2 milliseconds. To utilize the remaining TXOP, the TXOP Holder offers TXOP sharing with the TXOP Responder. The Responder, however, does not have any AC_VI data to send to the TXOP Holder, but does have AC_VI traffic for Third-party STAs. To accommodate this, the TXOP Holder decides to permit using the TXOP by the Responder for communication with Third-party STAs.

Various embodiments described herein provide for offering to a TXOP Responder to communicate with Third-party STAs. For example, some embodiments enable the TXOP Holder to offer to a Responder to communicate with Third-party STAs. As illustrated in FIG. 7, the TXOP Holder may use the following values in the TSO frame to make this offer: RDG/More PPDU=0 and AC Constraint=1. The Responder may accept or decline the offer (e.g., with or without a counteroffer), depending on its traffic exchange requirements.

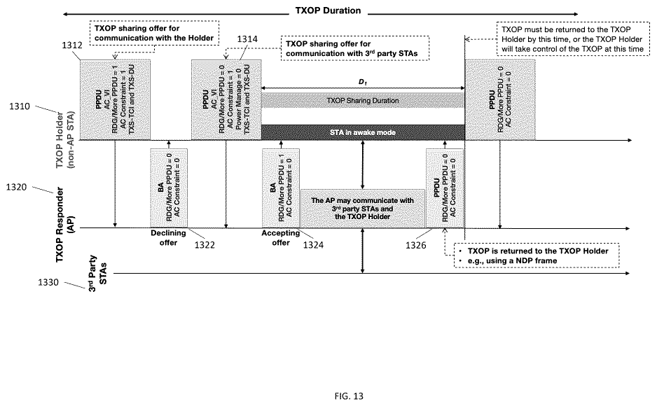

FIG. 13 illustrates an example of enabling a TXOP Responder to communicate with Third-party STAs. The TXOP Holder 1310 is a non-AP STA. The TXOP Holder 1310 makes an offer 1312 to the TXOP Responder 1320, offering to perform Responder-to-Holder communication. However, the TXOP Responder 1320 declines the offer 1312 via the response frame 1322. Then, the TXOP Holder 1310 sends another TSO 1314, where RDG/More PPDU=0 and AC Constraint=1, which offers the TXOP Responder 1320 to communicate with one or more Third-party STAs 1330. The TXOP Responder 1320 accepts the TSO 1314 by setting RDG/More PPDU=1 and AC Constraint=0 in its response frame 1324. The TXOP Holder 1310 chooses to stay awake (Power Manage=0) during the shared TXOP, and the TXOP Responder 1320 may communicate with the one or more Third-party STAs 1330 and the TXOP Holder 1310. To return the TXOP to the TXOP Holder 1310, the TXOP Responder 1320 sends a PPDU 1326 to the TXOP Holder 1310, where RDG/More PPDU=0 and AC Constraint=0. The last PPDU 1326, for example, may be NDP.

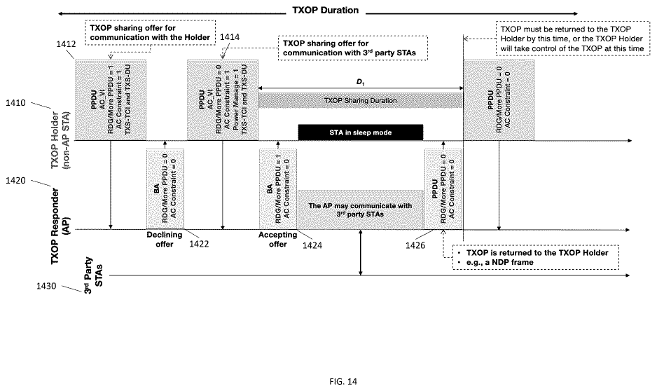

FIG. 14 illustrates another example of enabling a TXOP Responder to communicate with Third-party STAs. The TXOP Holder 1410 is a non-AP STA. The TXOP Holder 1410 makes an offer 1412 to the TXOP Responder 1420, offering to perform Responder-to-Holder communication. However, the TXOP Responder 1420 declines the offer 1412 via the response frame 1422. Then, the TXOP Holder 1410 sends another TSO 1414, with RDG/More PPDU=0 and AC Constraint=1, to offer the TXOP Responder 1420 to communicate with Third-party STAs 1430. The TXOP Responder 1420 accepts the TSO 1414 by setting RDG/More PPDU=1 and AC Constraint=0 in its response frame 1424. The TXOP Holder 1410 switches to sleep mode (Power Manage=1) during a portion of the shared TXOP. The TXOP Responder 1420 may now communicate with Third-party STAs 1430. To return the TXOP to the TXOP Holder 1410, the TXOP Responder 1420 sends a PPDU 1426 to the TXOP Holder 1410, where RDG/More PPDU=0 and AC Constraint=0. This last PPDU 1426, for example, may be an NDP.

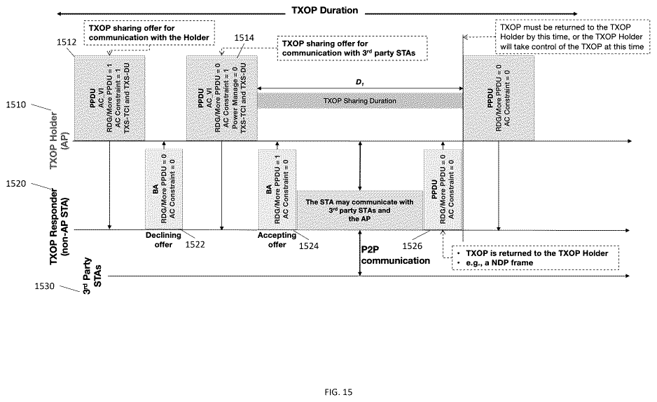

FIG. 15 illustrates another example of enabling a TXOP Responder to communicate with Third-party STAs. The TXOP Holder 1510 is an AP STA. The TXOP Holder 1510 sends a TSO 1512 to the TXOP Responder 1520, offering to perform Responder-to-Holder communication. However, the TXOP Responder 1520 declines the TSO 1512 via its response frame 1522. Then, the TXOP Holder 1510 sends another TSO 1514, where RDG/More PPDU=0 and AC Constraint=1, to offer to the TXOP Responder 1520 to communicate with Third-party STAs 1530. The TXOP Responder 1520 accepts the TSO 1514 by setting RDG/More PPDU=1 and AC Constraint=0 in its response frame 1524. As a non-AP STA, TXOP Responder 1520 may communicate with the TXOP Holder 1510 and Third-party STAs 1530. In some examples, the communication with Third-party STAs 1530 may be via peer-to-peer (P2P) links. To return the TXOP to the TXOP Holder 1510, the TXOP Responder 1520 sends a PPDU 1526 to the TXOP Holder 1510, where RDG/More PPDU=0 and AC Constraint=0. The last PPDU 1526, for example, may be a Null Data Packet (NDP).

Some embodiments described herein provide technical improvements to the RD protocol by enabling requesting for TXOP sharing. Example embodiments enable a TXOP Responder to request TXOP sharing from the Holder. For example, a Responder may send a request frame to the Holder if the Holder expects to receive at least one frame from the Responder. In some examples, when a TXOP Responder requests the Holder to share its TXOP, it may send two types of requests. For example, the first type may be for sharing the TXOP to communicate with the Holder, and the second type may be for sharing the TXOP to communicate with one or more Third-party STAs. In various examples, to request a shared TXOP, the Responder may use the following two request types: (1) for communicating with the Holder: RDG/More PPDU=1 and AC Constraint=1; (2) for communicating with Third-party STAs: RDG/More PPDU=0 and AC Constraint=1.

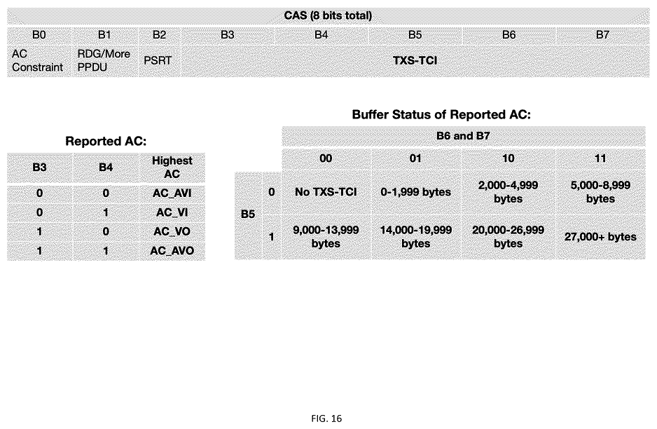

Certain embodiments described herein provide for conveying the minimum required sharing duration and permissible traffic types/streams. For example, when requesting TXOP sharing, a Responder may use the TXS-DU subfield described herein to indicate the minimum requested sharing duration. Additionally, in some examples, a Responder may use the TXS-TCI subfield described herein to indicate the type and/or amount of its buffered data to indicate the traffic types that it requests to exchange during the shared TXOP. For example, for the TXS-TCI subfield, if the field's length is 5 bits, the first 2 bits may indicate the highest buffered AC, and the next 3 bits may indicate the amount of data buffered. An example of encodings for the TXS-TCI subfield is illustrated in FIG. 16. By using an encoding scheme, in various embodiments, the Responder may convey detailed information about its buffered data to the Holder. It may be assumed LL traffic ACs are alternative video (AC_AVI), video (AC_VI), voice (AC_VO), and alternative voice (AC_AVO). These ACs are defined in the 802.11aa standard.

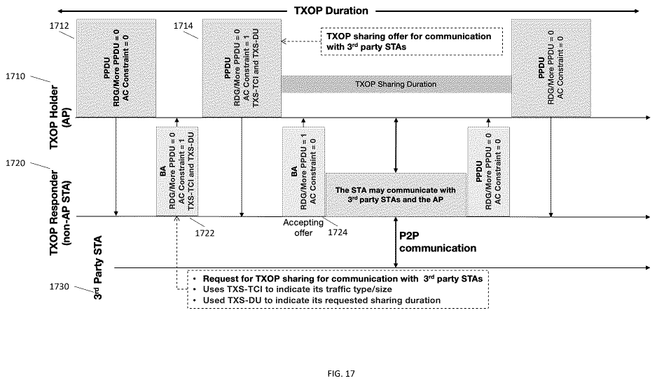

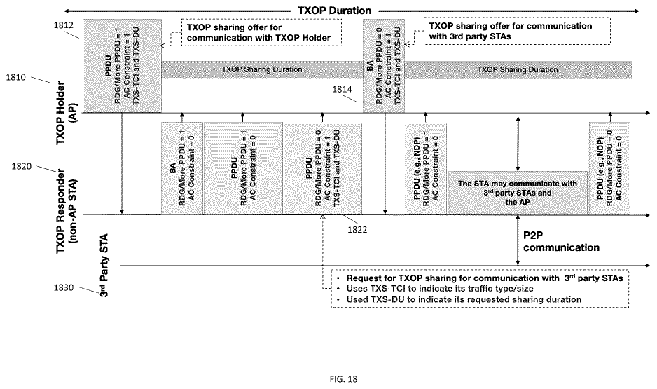

Various embodiments described herein provide for when and how to send a TXOP sharing request. In various embodiments, the request for TXOP sharing may be sent by a TXOP Responder under one of the following two cases: Case 1: No ongoing sharing period. The Responder may make a request when sending an ACK/BA frame to the Holder. An example of this is illustrated in FIG. 17. Case 2: An ongoing sharing period where the TXOP is already shared with the TXOP Responder. In the example illustrated in FIG. 18, the TXOP is shared with the Responder to communicate with the Holder, however, the Responder needs to communicate with Third-party STAs. In various examples, when sending PPDUs to the Holder, the Responder may use the combination RDG/More PPDU=1 and AC Constraint=0 in all of its frames, except the last one. Accordingly, to request a new sharing instance, in some examples, the Responder may need to end the current sharing instance while also making a new request. This may be achieved in some examples by sending a frame where RDG/More PPDU=0 and AC Constraint=1.

As shown in FIG. 17, first, the TXOP Holder 1710 is sending non-TSO frames 1712 to the TXOP Responder 1720. Using a BA frame 1722, the TXOP Responder 1720 requests permission from the TXOP Holder 1710 to communicate with Third-party STAs 1730. The BA frame 1722 includes a TXS-TCI subfield to specify the types of traffic that the TXOP Responder 1720 intends to exchange, and a TXS-DU subfield to indicate the minimum required duration for TXOP sharing. The TXOP Holder 1710 makes an offer 1714 to the TXOP Responder 1720 based on the received BA frame 1722. The TXOP Responder 1720 accepts the offer 1714 via the response frame 1724 and may communicate with Third-party STAs 1730 and/or the TXOP Holder 1710. In some examples, communication with TXOP Holder 1710 is allowed if the shared TXOP allows communication with Third-party STAs 1730.

FIG. 18 illustrates another example of the TXOP Responder requests for TXOP sharing. First, the TXOP Holder 1810 sends an offer 1812 that allows the TXOP Responder 1820 to communicate with the TXOP Holder 1810. The TXOP Responder 1820 accepts the offer 1812 and communicates with the TXOP Holder 1810. Then, the TXOP Responder 1820 terminates the TXOP sharing via a frame 1822 that also requests a sharing offer to communicate with Third-party STAs 1830. The TXOP Holder 1810 accepts the request of the frame 1822 by sending an offer 1814 that allows the TXOP Responder 1820 to communicate with Third-party STAs 1830.

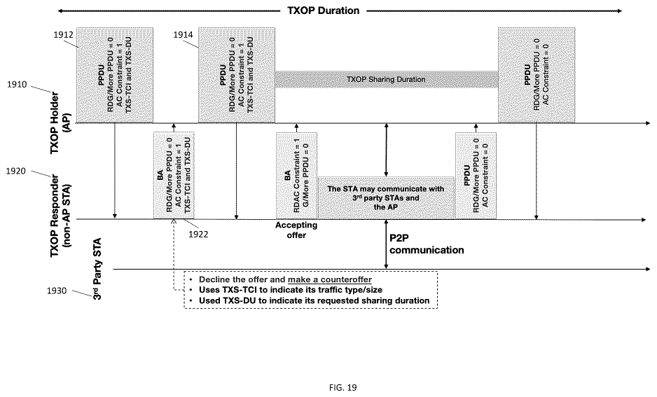

Various embodiments described herein provide for sending counteroffers. For example, when a Responder receives an offer, if the offer does not align with its needs, it may make a counteroffer. In some examples, the counteroffer may be sent via BA or other types of PPDUs such as NDPs. An example of this is illustrated in FIG. 19.

As shown in FIG. 19, first, the TXOP Holder 1910 sends an offer 1912 that allows the TXOP Responder 1920 to communicate with Third-party STAs 1930. However, the permissible traffic types or the offered TXOP duration do not align with the needs of the TXOP Responder 1920. Accordingly, the TXOP Responder 1920 declines the offer 1912 by sending a counteroffer 1922 to the TXOP Holder 1910, where the counteroffer 1922 is asking for permission to communicate with Third-party STAs 1930 while also specifying the minimum requested sharing duration and the traffic types that the TXOP Responder 1920 needs to exchange. The TXOP Holder 1910 sends a new offer 1914 meeting the demands of the TXOP Responder 1920. The TXOP Responder 1920 accepts the offer 1914 and proceeds.

In an example, assume that: (1) the TXOP Holder sends a TSO allowing the Responder to communicate with Third-party STAs, (2) the Holder indicates that it intends to sleep (Power Manage=1) during the shared TXOP, and (3) the sharing duration is less than the remaining TXOP duration. In this example, the following restriction on the TXOP Responder may apply: The TXOP Responder may be responsible for rejecting the TSO or making a counteroffer if the Responder does not have enough data of the permitted ACs to utilize the entire sharing duration. This restriction, for example, may prevent the undesirable scenario where the TXOP Responder cannot use the channel because: (1) it has sent all of its queued data, (2) the Responder cannot release the channel (e.g., transmit a contention free (CF)-End frame) because it is required to return channel control to the Holder after the sharing duration, and (3) the Responder cannot return the channel to the TXOP Holder because the Holder is asleep. In certain examples, when the said restriction applies, the TXOP Responder may reject the TSO and make a simultaneous counteroffer (e.g., requesting less sharing duration or more permissible ACs so that it can fill the time) if it so chooses. For example, suppose the sharing duration equals the remaining TXOP duration (e.g., the Holder has shared the remaining TXOP). In this example, the Responder may have to terminate the TXOP when it is finished transmitting data because it is not required to return the TXOP to the TXOP Holder. As another example, suppose the TXOP Holder did not indicate that it would sleep for the sharing duration (e.g., Power Manage=0 in the TSO). In this example, the Responder may simply return the TXOP to the Holder (by sending a PPDU with RDG/More PPDU=0 and AC Constraint=0 to the Holder) when it is finished transmitting its data.

In an example, a STAx may acquire a TXOP for a certain duration and the TXOP may be currently ongoing. In this example, the STAx may offer to share a portion of its TXOP at any time to any STAs, where the offer is sent via a frame that specifies: (1) if the recipient of the offer can communicate with STAX only, or if the recipient of the offer can communicate with the STAx and other STAs, (2) the maximum sharing duration, (3) and the permissible traffic types or streams that can be exchanged during the shared TXOP. Further, in this example, the TXOP sharing offer may be a frame that uses the extended encodings described herein of the two signaling subfields (bits) of the Reverse Direction (RD) protocol (available in 802.11ax/be) that are used in the MAC header of PPDUs. In this example, the two signaling subfields of the RD protocol (in the 802.11ax/be standards) are: (1) RDG/More PPDU, and (2) AC Constraint; and the extended encodings described herein for these two subfields are used to convey new meanings. In the traditional RD protocol, these two subfields/bits are used to allow the recipient to send to the Holder; using the extended encodings described herein, in this example, these two subfields/bits may be used to inform the recipient that it can communicate with Third-party STAs as well. Additionally, in this example, the TXOP sharing offer may be a frame that uses the two new subfields described herein in the MAC header, where the two new subfields are: (1) TXOP Sharing-Traffic Characteristics Indication (TXS-TCI), and (2) TXOP Sharing-Duration (TXS-DU).

In various embodiments of the proposed enhanced protocol described herein, when the two new subfields TXS-TCI and TXS-DU are used in an offer frame, they may be used to convey the permissible traffic types (or streams) and the duration of the TXOP sharing. Additionally, in some embodiments, the TXOP sharing offer may limit the recipient to communicate only with the Holder during the shared TXOP. Additionally or alternatively, in certain embodiments, the TXOP sharing offer may limit the traffic types and/or streams that the recipient is allowed to send to the Holder during the shared TXOP. Additionally or alternatively, in various embodiments, the TXOP sharing offer may allow the recipient to communicate with one or more Third-party STAs, in addition to the Holder, during the shared TXOP. As used herein, a Third-party STA refers to any STA other than the TXOP Holder and TXOP Responder (recipient of the offer). Additionally or alternatively, in some embodiments, the TXOP sharing offer may specify the traffic types and/or streams that the recipient can communicate with Third-party STAs and the Holder during the shared TXOP.

In some embodiments, a STAY that accepts an offer from a STAx to communicate with the STAx (with/without permission to communicate with Third-party STAs) can send ACK soliciting frames to the STAx during the shared TXOP. In such an embodiment, using its response frames to STAY, STAx may: terminate the ongoing TXOP sharing instance; change the duration of the ongoing TXOP sharing instance; change the permitted traffic types/streams; and/or change whether STAY is permitted to communicate with Third-party STAs.

In various embodiments, a STAY that receives an offer from STAx, may accept the offer, decline the offer, or respond with a counteroffer. In an embodiment where the STAY responds with a counteroffer, the counteroffer information may be encoded in the MAC header of the ACK/BA frame sent in response to the offer. Additionally, in such an embodiment, to decide about its response, and in addition to considering its current traffic demand, STAY may rely on factors including, but not limited to the following: the permissible traffic types conveyed in the TXOP sharing offer from STAx; the TXOP sharing duration conveyed in the TXOP sharing offer from STAx; and/or whether the TXOP sharing offer allows STAY to communicate with Third-party stations.

In certain embodiments, a PPDU frame sent by STAx, if it does not offer TXOP sharing, may indicate the minimum or exact duration until the next TXOP sharing instance. For example, such a frame may use the TXOP Sharing-Duration (TXS-DU) subfield.

In some embodiments, TXOP sharing may be requested. For example, when a STAx is sending to a STAY and there is no ongoing TXOP sharing, STAY can request for TXOP sharing via a response frame that it sends to STAx. For example, such a request may be a frame that uses: (1) new encodings of the two signaling bits of the Reverse Direction (RD) protocol that are used in the MAC header (e.g., RDG/More PPDU and AC Constraint), and (2) the two new proposed subfields in the MAC header (e.g., TXS-TCI and TXS-DU). In some examples, when there is an ongoing TXOP sharing with a STAY, the STAY may terminate the shared TXOP and return it to a STAx via a frame that is also serving as a request frame. For example, such a request may be a frame that uses: (1) new encodings of the two signaling bits of the Reverse Direction (RD) protocol that are used in the MAC header (e.g., RDG/More PPDU and AC Constraint), and (2) the two new proposed subfields in the MAC header (e.g., TXS-TCI and TXS-DU).

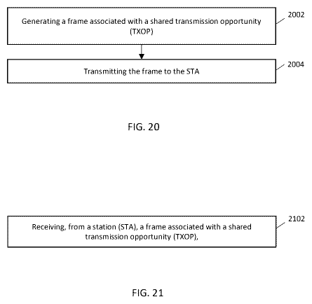

Referring now to FIG. 20, the operations performed in order to generate and transmit a frame associated with a TXOP are illustrated. As shown in block 2002 of FIG. 20, a frame associated with a shared transmission opportunity (TXOP) is generated. By way of example, the apparatus 200 includes means, such as the processor 205 or the like, for generating the frame. The frame indicates at least one of (i) whether a station (STA) can communicate during the shared TXOP with (a) the apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP.

As shown in block 2004 of FIG. 20, the apparatus 200 includes means, such as the processor 205, the communication interface 215 or the like, for transmitting the frame to the STA.

Referring now to FIG. 21, the operations performed in order to receive a frame associated with a TXOP are illustrated. As shown in block 2102 of FIG. 21, a frame associated with a shared transmission opportunity (TXOP) may be received from a station (STA). By way of example, the apparatus 200 may include means, such as the processor 205, the communication interface 215 or the like, for receiving the frame. The frame indicates at least one of (i) whether the apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

FIGS. 20 and 21 are flowcharts illustrating methods according to example embodiments. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 210 of an apparatus 200 employing an example embodiment and executed by at least one processor 205. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an embodiment, at least some of the processes described herein may be carried out by an apparatus comprising means for carrying out at least some of the described processes. Means for performing method steps as disclosed herein may include software and/or hardware components of the apparatus 200. For example, the at least one processor 205, the memory 210, and the computer program code form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

That which is claimed:

1. An apparatus comprising at least one processor and at least one memory storing instructions that, when executed by the at least one processor, cause the apparatus to perform at least:
generating a frame associated with a shared transmission opportunity (TXOP), wherein the frame indicates at least one of (i) whether a station (STA) can communicate during the shared TXOP with (a) the apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP; and
transmitting the frame to the STA.

2. The apparatus according to claim 1, wherein the frame comprises at least two subfields encoded to indicate whether the STA can communicate during the shared TXOP with (a) the apparatus or (b) the apparatus and the one or more other STAs.

3. The apparatus according to claim 2, wherein the at least two subfields comprise at least one of extended encodings of a reverse direction grant (RDG) subfield or extended encodings of an access category (AC) constraint subfield.

4. The apparatus according to claim 1, wherein the frame comprises at least one of a TXOP Sharing-Traffic Characteristics Indication (TXS-TCI) subfield or a TXOP Sharing-Duration (TXS-DU) subfield.

5. The apparatus according to claim 4, wherein the TXS-TCI subfield indicates at least one of the one or more permissible traffic types that can be communicated during the shared TXOP or the one or more permissible streams that can be communicated during the shared TXOP.

6. The apparatus according to claim 4, wherein the TXS-DU subfield indicates the maximum duration of the shared TXOP during which the STA can communicate.

7. The apparatus according to claim 1, wherein the instructions, when executed by the at least one processor, further cause the apparatus to perform at least:
receiving a response frame from the STA, wherein the response frame from the STA indicates at least one of the following: that the STA accepts the shared TXOP, that the STA does not accept the shared TXOP, or that the STA has provided a counteroffer.

8. The apparatus according to claim 7, wherein the counteroffer from the STA indicates at least one of a request to communicate with the apparatus, or a request to communicate with the apparatus and one or more other STAs, or one or more permissible traffic types to be communicated, or one or more permissible streams to be communicated, or a minimum duration of the shared TXOP during which the STA can communicate.

9. The apparatus according to claim 8, wherein the instructions, when executed by the at least one processor, further cause the apparatus to perform at least:
receiving a response frame from the STA indicating the counteroffer from the STA;
generating a second frame based at least in part on the counteroffer from the STA; and
transmitting the second frame to the STA.

10. The apparatus according to claim 1, wherein the instructions, when executed by the at least one processor, further cause the apparatus to perform at least:
generating a second frame during the shared TXOP, wherein the second frame indicates an update to at least one of whether the STA can communicate during the shared TXOP with (a) the apparatus or (b) the apparatus and one or more other STAs, or the maximum duration of the shared TXOP during which the STA can communicate, or one or more permissible traffic types that can be communicated during the shared TXOP, or one or more permissible streams that can be communicated during the shared TXOP, or wherein the second frame indicates a termination of the shared TXOP; and
transmitting the second frame to the STA during the shared TXOP.

11. The apparatus according to claim 1, wherein the frame indicates a minimum duration or an exact duration until a next shared TXOP instance without providing a TXOP offer.

12. The apparatus according to claim 1, wherein the instructions, when executed by the at least one processor, further cause the apparatus to perform at least:
receiving a frame from the STA, wherein the frame is a request for a shared TXOP;
generating a second frame based at least in part on the request for a shared TXOP; and
transmitting the second frame to the STA.

13. The apparatus according to claim 1, wherein the instructions, when executed by the at least one processor, further cause the apparatus to perform at least:
receiving a frame from the STA, wherein:
the frame is a request received during the shared TXOP,
the request indicates a termination of the TXOP, and
the request indicates a request for a new shared TXOP.

14. The apparatus according to claim 1, wherein the apparatus comprises an access point (AP) STA or a non-AP STA.

15. A method comprising:
generating a frame associated with a shared transmission opportunity (TXOP), wherein the frame indicates at least one of (i) whether a station (STA) can communicate during the shared TXOP with (a) an apparatus or (b) the apparatus and one or more other STAs, (ii) a maximum duration of the shared TXOP during which the STA can communicate, or (iii) at least one of one or more permissible traffic types that can be communicated during the shared TXOP or one or more permissible streams that can be communicated during the shared TXOP; and
transmitting the frame to the STA.

16. An apparatus comprising at least one processor and at least one memory storing instructions that, when executed by the at least one processor, cause the apparatus to perform at least:
receiving, from a station (STA), a frame associated with a shared transmission opportunity (TXOP), wherein the frame indicates at least one of (i) whether the apparatus can communicate during the shared TXOP with (a) the STA or (b) the STA and one or more other STAs, (ii) a maximum duration of the shared TXOP during which the apparatus can communicate, or (iii) at least one of one or more permissible traffic types that can be communicated during the shared TXOP or one or more permissible streams that can be communicated during the shared TXOP.

17. The apparatus according to claim 16, wherein the instructions, when executed by the at least one processor, further cause the apparatus to perform at least:
determining to not respond to the frame received from the STA.

18. The apparatus according to claim 16, wherein the instructions, when executed by the at least one processor, further cause the apparatus to perform at least:
generating, based at least in part on the frame received from the STA, a response frame, wherein the response frame indicates at least one of the following: that the shared TXOP is accepted, that the shared TXOP is not accepted, or a counteroffer; and
transmitting the response frame to the STA.

19. The apparatus according to claim 18, wherein the counteroffer indicates at least one of a request to communicate with the STA, or a request to communicate with the STA and one or more other STAs, or one or more permissible traffic types to be communicated, or one or more permissible streams to be communicated, or a minimum duration of the shared TXOP during which the apparatus can communicate.

20. The apparatus according to claim 19, wherein the instructions, when executed by the at least one processor, further cause the apparatus to perform at least:
generating a response frame indicating the counteroffer based at least in part on the received frame and one or more current traffic demands of the apparatus; and
transmitting the response frame to the STA.
